(19) United States
(12) Patent Application Publication
(10) Pub. No.: US 2025/0002746 A1
(43) Pub. Date: Jan. 2, 2025

(54) HARD COAT FILM

(71) Applicant: NIPPON PAPER INDUSTRIES CO., LTD., Tokyo (JP)

(72) Inventors: Yuki SAKAMOTO, Tokyo (JP); Shotaro TOYA, Tokyo (JP); Masahide HASEGAWA, Tokyo (JP)

(73) Assignee: NIPPON PAPER INDUSTRIES CO., LTD., Tokyo (JP)

(21) Appl. No.: 18/696,485

(22) PCT Filed: Sep. 27, 2022
(86) PCT No.: PCT/JP2022/035969

§ 371 Date: Mar. 28, 2024

(30) Foreign Application Priority Data
Sep. 29, 2021 (JP) 2021-158621
Mar. 30, 2022 (JP) 2022-056686

(51) Int. Cl. C09D 133/14; C08J 7/04; C08K 3/36; C09D 4/00; C09D 7/61

(52) U.S. Cl. CPC C09D 133/14; C08J 7/0427; C09D 4/00; C09D 7/61; C08J 2333/14; C08J 2367/02; C08K 3/36

(57) ABSTRACT

The present invention provides a hard coat film having high heat resistance and dimensional stability and being excellent in optical properties. A hard coat film of the present invention is a hard coat film including hard coat layers on both surfaces of a base material film, each hard coat layer containing an ionizing radiation curable resin composition, the hard coat film satisfying the following conditions (I) and (II), and having a maximum value of a heat shrinkage rate of 1.2% or less after the hard coat film is heat-treated at 150° C. to 200° C. for 1 minute to 30 minutes:
condition (I): the ionizing radiation curable resin composition contains an acrylic resin including a (meth)acryloyl group; and
condition (II): the ionizing radiation curable resin composition contains inorganic fine particles or organic fine particles.

### TECHNICAL FIELD

The present invention relates to a hard coat film, in more detail, to a hard coat film provided with a hard coat layer, which can be used as members of flat panel display's and touch panels of liquid crystal display devices, plasma display devices, and electroluminescence (EL) display devices, a base film of a carrier film, a flexible substrate, and the like.

### BACKGROUND ART

It is required to provide scratch resistance to a display surface of a flat panel display such as a liquid crystal display (LCD) device such that the visibility may not be degraded due to being damaged during handling. Accordingly, it is common to provide scratch resistance by using a hard coat film provided with a hard coat layer on a base material film. In recent years, with popularization of a touch panel to which data or instructions can be input by touching with a finger or a pen while watching a display on a display screen, whitening of the appearance has been suppressed, and functional requirements for hard coat films having high total light transmittance and low haze is increasing.

On the other hand, the needs of base films such as carrier films and flexible substrates have become more complicated in recent years, and materials and technologies to achieve new electronics are required. A demand for a film with excellent heat resistance (dimensional stability) with respect to heat and adhesion with laminated films to be formed on the films is increasing. Therefore, various types of base material films are provided with a hard coat layer (functional layer) to provide performance that cannot be obtained by the base material films alone, and high-function films that can meet the demand for further high performance are required.

Therefore, as base material films, polyethylene terephthalate, polyethylene naphthalate, triacetylcellulose, and cycloolefins having excellent transparency, heat resistance, dimensional stability, and low moisture absorbency, further polyimides and liquid crystal polymers having excellent dimensional stability are expected to be used for applications of optical members and electronic members. With the diversification of applications in recent years, a hard coat film provided with a hard coat layer on the base material film for further providing hardness is required not only to have excellent adhesion between the base material film and the hard coat layer, but also to have excellent optical properties, heat resistance, and adhesion with a laminated film.

Conventionally, for example, Patent Literatures 1 and 2, and the like, disclose a method for providing a base material film such as a cycloolefin film having particularly excellent optical property with an easy bonding property with a hard coat layer. Patent Literature 1 discloses a method for subjecting a surface of a base film to corona treatment, plasma treatment, UV treatment, and the like, and Patent Literature 2 discloses painting an anchor coat agent to the base material film (anchor coat treatment).

### CITATION LIST

### Patent Literature

Patent Literature 1: Japanese Patent Application Publication No. 2001-147304
Patent Literature 2: Japanese Patent Application Publication No. 2006-110875

### SUMMARY OF INVENTION

### Technical Problem

Furthermore, in base films such as flexible substrates, high heat resistance (dimensional stability) is required. For example, it is required that degradation in appearance, shape change, or change in optical properties (for example, haze, and the like) do not occur in films after heat treatment.

Thus, an object of the present invention is to provide a hard coat film having high heat resistance and dimensional stability, and being excellent in optical properties.

### Solution to Problem

The inventors of the present invention have studied hard to solve the above-mentioned problems, and found that a hard coat film excellent in heat resistance and also excellent in optical properties can be obtained by annealing in addition to hard coating, since the hard coating enables heat treatment to be carried out at high temperature.

In other words, the present invention includes the following configuration.

### (First Invention)

A hard coat film provided with hard coat layers on both surfaces of a base material film, each hard coat layer containing an ionizing radiation curable resin composition, the hard coat film satisfying the following conditions (I) and (II), and having a maximum value of a heat shrinkage rate of 1.2% or less after the hard coat film is heat-treated at 150° C. to 200° C. for 1 minute to 30 minutes:
condition (I): the ionizing radiation curable resin composition contains an acrylic resin including a (meth)acryloyl group; and
condition (II): the ionizing radiation curable resin composition contains inorganic fine particles or organic fine particles.

### (Second Invention)

The hard coat film described in the first invention, wherein a content of the inorganic fine particles or the organic fine particles is in a range from 1% by mass to 60% by mass relative to a solid content of the ionizing radiation curable resin composition.

### (Third Invention)

The hard coat film described in the first and second inventions, wherein when D_{A} denotes a film thickness of a hard coat layer A on a first surface of the base material film and D_{B} denotes a film thickness of a hard coat layer B on a second surface of the base material film, the film thickness D_{A} of the hard coat layer A and the film thickness D_{B} of the hard coat layer B are both in a range from 0.5 μm to 12.0 μm.

### (Fourth Invention)

The hard coat film according to any one of the first to third inventions, wherein a film thickness ratio ((D_{A}/D_{B})×100) of the hard coat layer A to the hard coat layer B is in a range from 50% to 150%.

### (Fifth Invention)

The hard coat film according to any one of the first to fourth inventions, wherein the base material film is selected from polyethylene terephthalate, cycloolefin, polyethylene naphthalate, polyimide, triacetylcellulose, and liquid crystal polymer.

### Advantageous Effect of Invention

The present invention can provide a hard coat film having high heat resistance and dimension stability, in which deterioration of appearance and change of shape are suppressed by carrying out annealing treatment in addition to hard coating.

### DESCRIPTION OF EMBODIMENTS

Hereinafter, embodiments for carrying out the present invention will be described in detail, but the present invention is not limited to the following embodiments.

Note here that in the present specification, unless especially stated otherwise, “(from) xx to yy” means “xx or more and yy or less”.

As described in the first invention, the present invention is a hard coat film including hard coat layers on both surfaces of a base material film, the hard coat film satisfying the following conditions (I) and (II), and having a maximum value of a heat shrinkage rate of 1.2% or less after the hard coat film is heat-treated at 150° C. to 200° C. for 1 minute to 30 minutes:
condition (I): the ionizing radiation curable resin composition contains an acrylic resin including a (meth)acryloyl group; and
condition (II): the ionizing radiation curable resin composition contains inorganic fine particles or organic fine particles.

The configuration of such a hard coat film of the present invention will be described in detail hereinafter.

### [Base Material Film]

Firstly, the base material film of a hard coat film according to the present invention will be described.

In the present invention, the base material film of the hard coat film is not particularly limited, and examples thereof can include films, sheets, or the like, of polyethylene terephthalate, polyimide, polyethylene, polypropylene, acrylic resin, polystyrene, triacetylcellulose, and polyvinyl chloride. Among them, polyethylene terephthalate, cycloolefin, polyethylene naphthalate, and polyimide, triacetylcellulose, and liquid crystal polymer, which have excellent heat resistance, dimensional stability, and the like, are preferable. Especially, polyethylene terephthalate that is inexpensive and easily available, and cycloolefin having excellent optical properties and low moisture absorbency are further preferable.

Further, in the present invention, a thickness of the base material film is appropriately selected according to an application to which the hard coat film is used, but from the viewpoint of mechanical strength, handling property, and the like, the thickness is preferably in the range from 10 μm to 300 μm, and more preferably in the range from 20 μm to 200 μm.

In the present invention, when the base material film is used for an application of a hard coat film, for the purpose of preventing a coated film from deteriorating or causing adhesion failure due to ultraviolet rays, a film obtained by forming a resin in which a resin constituting a base material film and a ultraviolet ray-absorbing agent are kneaded into a shape of film or a film obtained by painting a coating material obtained by mixing a thermoplastic or thermosetting resin and a UV-absorbing agent onto one surface or both surfaces of the base material film may be used.

### [Hard Coat Layer]

Next, the hard coat layer will be described.

In the present invention, the hard coat layer contains an ionizing radiation curable resin composition. The hard coat layer is formed of a cured coating film of the ionizing radiation curable resin composition.

As the resin contained in the hard coat layer, an ionizing radiation curable resin composition is preferably used, in particular, from the viewpoint of providing surface hardness (pencil hardness, scratch resistance) of the hard coat layer, being capable of adjusting a degree of crosslinking depending on an exposure amount of ultraviolet ray, and being capable of adjusting the surface hardness of the hard coat layer.

In the present invention, the ionizing radiation curable resin composition contains an acrylic resin including a (meth)acryloyl group (the condition (I) mentioned above).

The ionizing radiation curable resin composition used in the present invention is a transparent resin that is cured by irradiation with ultraviolet rays (hereinafter, abbreviated as “UV”) or an electron beam (hereinafter, abbreviated as “EB”), preferably includes an acrylic resin including a (meth)acryloyl group, and more preferably is a urethane acrylate resin including a (meth)acryloyl group.

As mentioned above, the ionizing radiation curable resin composition used in the present invention further contains inorganic fine particles or organic fine particles (the condition (II) mentioned above). Containing inorganic fine particles or organic fine particles enables the surface hardness (scratch resistance) or surface smoothness of the hard coat layer to be improved. In addition, as described above, it contributes also to improvement of the heat resistance of the hard coat film.

In this case, the average particle diameter of the inorganic fine particles or organic fine particles is preferably in a range from 1 nm to 500 nm, and further preferably in a range from 10 nm to 100 nm. The average particle diameter of less than 1 nm makes it difficult to obtain sufficient surface hardness. On the other hand, the average particle diameter of more than 150 nm may deteriorate gloss and transparency of the hard coat layer, and may also deteriorate flexibility.

Examples of the inorganic fine particles or organic fine particle can include silica, alumina, acrylic resin, silicone resin, and the like.

In the present invention, it is particularly suitable to contain silica that is an inorganic fine particle having an excellent appearance of a hard coat film, a very high binding energy, and excellent thermal stability.

In the present invention, a content of the inorganic fine particles or organic fine particles is preferably in a range from 1% by mass to 60% by mass, and particularly preferably in a range from 15% by mass to 50% by mass relative to a solid content of the ionizing radiation curable resin composition. When the content is less than 1% by mass, it is difficult to obtain an improvement effect of the surface hardness (scratch resistance) or an improvement effect of the heat resistance. On the other hand, it is not preferable when the content is more than 60% by mass because flexibility is deteriorated or haze is increased.

Furthermore, the ionizing radiation curable resin composition may include a thermoplastic resin such as polyethylene, polypropylene, polystyrene, polycarbonate, polyester, styrene-acrylic, or fibrin, or a thermosetting resin such as a phenolic resin, a urea resin, unsaturated polyester, epoxy, or a silicon resin, in addition to the acrylic resin including a (meth)acryloyl group, within a range that does not damage the effect of the present invention, the hardness of the hard coat layer, or the scratch resistance.

Further, as a photopolymerization initiator of the ionizing radiation curable resin composition is not particularly limited, and acetophenones such as commercially available Omnirad 651 and Omnirad 184 (both are trade names, manufactured by IMG) and benzophenones such as Omnirad 500 (trade name, manufactured by IMG) can be used.

### [Hard Coat Film]

The hard coat film of the present invention is a hard coat film in which a hard coat layer is formed on both surfaces of a base material film using an ionizing radiation curable resin composition satisfying the conditions described above.

For the hard coat layer, a levelling agent may be used for the purpose of improving the coating property. Examples thereof include the well-known levelling agents such as a fluorine-based levelling agent, an acrylic-based levelling agent, a siloxane-based levelling agent, and adducts or mixtures thereof. A blending amount can be in the range from 0.01 parts by mass to 7 parts by mass relative to 100 parts by mass of the solid content of the hard coat layer. Further, in applications to touch panels or the like, in the case where an anti-bonding property using an optically transparent resin OCR is required for the purpose of bonding with a cover glass (CG), a transparent conductive member (TSP), a liquid crystal module (LCM), or the like, of a touch panel terminal, an acrylic-based levelling agent or a fluorine-based levelling agent having high surface free energy (about 40 mJ/cm² or higher) is preferably used.

As the other additives to be added to the hard coat layer, a defoaming agent, a surface tension controlling agent, an antifouling agent, an antioxidant, an antistatic agent, a UV-absorbing agent, a light stabilizer, or the like, may be added if necessary, in the range that does not damage the effect of the present invention.

The hard coat layer is formed by coating the base material film with a coating material obtained by dissolving or dispersing the ionizing radiation curable resin composition, a photopolymerization initiator, and other additives in an appropriate solvent, followed by drying. As the solvent, any solvent can be appropriately selected according to the solubility of the resin to be blended and may be a solvent capable of uniformly dissolving or dispersing at least the solid content (resin, polymerization initiator, and other additives). As such a solvent, well-known organic solvents, for example, aromatic-based solvents such as toluene, xylene, and n-heptane: aliphatic-based solvents such as cyclohexane, methyl cyclohexane, and ethyl cyclohexane: ester-based solvents such as methyl acetate, ethyl acetate, propyl acetate, isopropyl acetate, butyl acetate, and methyl lactate: ketone-based solvents such as acetone, methyl ethyl ketone, methyl isobutyl ketone, and cyclohexanone; and alcohol-based solvents such as methanol, ethanol, isopropyl alcohol, and n-propyl alcohol can be used alone or also in combination of appropriate number of kinds.

The coating method of the hard coat layer is not particularly limited. Coating is carried out by a well-known coating method such as a gravure coating, a micro gravure coating, a fountain-bar coating, a slide die coating, a slot die coating, a spin coating, a screen printing method, or a spray coating method, followed by drying usually at temperatures from about 50° C. to 120° C.

In the present invention, a cured coating film (hard coat layer) excellent in hardness can be obtained in which the base material film is coated with a hard coat layer coating material containing the ionizing radiation curable resin composition or the like, and dried, followed by irradiation with ionizing radiation rays (UV, EB, or the like) to cause photopolymerization. In particular, it is preferably a hard coat layer that is not easily scratched after being rubbed with steel wool. The irradiation amount of the ionizing radiation (UV, EB, or the like) to the dried coating film is only required to be an irradiation amount that need to bring sufficient hardness to the hard coat layer, and the amount can be appropriately set according to types or the like of the ionizing radiation curable resin.

The hard coat film of the present invention is a hard coat film provided with hard coat layers on both surfaces of a base material film.

A film thickness of the hard coat layer is not particularly limited, but when a film thickness D_{A} of a hard coat layer A and a film thickness D_{B} of a hard coat layer B are both in a range from 0.5 μm to 12.0 μm, and particularly preferably in a range from 0.5 μm to 9.0 μm, wherein D_{A} denotes a film thickness of the hard coat layer A on a first surface of the base material film and D_{B} denotes a film thickness of the hard coat layer B on a second surface of the base material film. When the film thickness is less than 0.5 μm, sufficient rigidity with respect to the hard coat layer cannot be obtained, and it becomes difficult to suppress thermal deformation of the base material film by the hard coat layer. Also, it is not preferable that the film thickness is more than 12.0 μm because the rigidity of the hard coat layer is remarkably improved, and the bending property and crack resistance of the hard coat layer remarkably decreases. In order to keep balance therebetween, the film thickness is suitably in a range from 1.0 μm to 7.0 μm.

Furthermore, a film thickness ratio ((D_{A}/D_{B})×100) of the hard coat layer A to the hard coat layer B is preferably in a range from 50% to 150%, and particularly preferably 80% to 120%. It is preferable that when the film thickness ratio of the hard coat layer A to the hard coat layer B is in the above ratio, curls of the hard coat layers A and B with curing contraction are offset.

The hard coat film mentioned above is subjected to annealing treatment. Annealing treatment is a method of removing residual stress in a film by heat treatment. Annealing treatment completely crystallizes and fixes molecules, improving dimensional stability. According to the present invention, the maximum value of the heat shrinkage rate is 1.2% or less. Annealing treatment is preferably carried out at high temperature for a short period of time, preferably about 40 minutes at the longest. In the present invention, the hard coat film is suitably heat-treated at 150° C. to 200° C. for 1 minute to 30 minutes.

As described above in detail, the present invention relates to a hard coat film provided with hard coat layers on both surfaces of a base material film, each hard coat layer containing an ionizing radiation curable resin composition, and satisfying the above-mentioned conditions (I) and (II). The present invention can provide a hard coat film having high heat resistance and dimension stability and suppressing deterioration of appearance and change of shape by carrying out annealing treatment in addition to hard coating.

### EXAMPLES

Hereinafter, the present invention will be specifically described with reference to Examples, but the present invention is not limited to the following Examples. Also, Comparative Examples and Reference Examples will be described.

Note here that unless otherwise particularly noted, “parts” described below represent “parts by mass”, and “%” described below represents “% by mass”.

### Example 1

### [Preparation of Resin Composition 1 for Forming Hard Coat Layer (Coating Material for Hard Coat Layer)]

A fluorine-based leveling agent was added to an ionizing radiation curable resin composition (containing a total 23% of urethane acrylate and acrylic ester including a (meth)acryloyl group, 15% amorphous silica, and 2% photopolymerization initiator, and a solvent containing 35% propylene glycol monomethyl ether, 15% methyl ethyl ketone and 10% toluene) so that a resin content ratio was 0.1% was used as a main component, and the solid content was adjusted to 28% with a diluent (a diluent including 65% 1-propanol and 35% diacetone alcohol).

As mentioned above, the resin composition 1 for forming a hard coat layer to be used for this Example was prepared.

### [Production of Hard Coat Film]

A base material film (trade name: “Cosmoshine A 4360”, thickness: 125 μm, manufactured by Toyobo Co., Ltd.) mainly including polyethylene terephthalate was used as a base material film, and the resin composition 1 for forming a hard coat layer mentioned above was coated on both surfaces of the base material film using a bar coater and then hot-air-dried in a drying furnace at 80° C. for 1 minute to form a coated layer having a coating thickness of 3.0 μm (one side). Note here that the coating film thickness was the same on both surfaces. The coating film thickness was measured using a Thin-Film Analyzer F20 (trade name) (manufactured by FILMETRICS).

The obtained product was cured using a UV irradiation device set at a height of 60 mm above the coating surface at a UV irradiation dose of 157 mJ/cm² to form hard coat layers on both surfaces of a base film to obtain a hard coat film. The obtained hard coat film was heat treated for 1 minute to 30 minutes in a furnace at 150° C. to 200° C., and subjected to annealing treated to obtain a hard coat film.

### Example 2

A hard coat film of Example 2 was produced by the same manner as in Example 1 except that a coating film thickness (one side) in Example 1 was 6.0 μm and anneal treatment was carried out only at 200° C.

### Comparative Examples 1 and 2

A hard coat film that has not subjected to annealing treatment was produced by the same manner as in Examples 1 and 2.

### Reference Example 1

As Reference Example 1, a base material film (trade name: Cosmoshine A 4360, thickness: 125 μm, manufactured by Toyobo Co., Ltd.) mainly including polyethylene terephthalate used for Examples and Comparative Examples described above was evaluated.

### Reference Example 2

As Reference Example 2, the base material film that had been subjected to annealing treatment in a drying furnace at 150° C. to 200° C. for 1 minute to 10 minutes in Reference Example 1 mentioned above to produce a base material film, and the following evaluation was carried out.

### <Evaluation Method>

The respective hard coat films of Examples and Comparative Examples obtained as described above and the base material film of Reference Example were evaluated according to the following methods and criteria, and results thereof are summarized in Table 1.

### (1) Optical Properties (Transmittance (Tt), Haze)

Measurement was carried out by using “Haze meter HM150” (manufactured by Murakami Color Research Laboratory Co., Ltd.) according to JIS-K-7361-1 and JIS-K-7136.

### (2) Heat Shrinkage Rate

Measurements were carried out using a digital small measurement microscope (manufactured by OLYMPUS Co., Ltd.) according to JIS-K-7133. Heat treatment was carried out at 150° C. for 30 minutes and at 200° C. for 30 minutes. Note here that the heat shrinkage rate was measured in the coating direction of the hard coat film (abbreviated as “MD”) and in the traverse direction (abbreviated as “TD”) perpendicular to MD.

### [Evaluation of Appearance]

Appearance (degree of whitening of a film surface, degree of precipitation of oligomer components from the inside of the base material film, and the like) of each film before and after heat treatment were compared and evaluated visually. The evaluation criteria are as follows:
O: No change was observed, X: Change was observed

TABLE 1

| | | | | | | | 150° C. × 30 min | | | | | 200° C. × 30 min | | | | |
|---|---|---|---|---|---|---|---|---|---|---|---|---|---|---|---|---|
| | | | | | | | Heat | | | | | Heat | | | | |
| | | Coating | Annealing | | Optical | | shrinkage | | | Optical | | shrinkage | | | Optical | |
| | Base | thickness | treatment | Appear- | property (%) | | rate (%) | | Appear- | property (%) | | rate (%) | | Appear- | property (%) | |
| No* | material | (μm) | condition | ance | Tt | Haze | MD | TD | ance | Tt | Haze | MD | TD | ance | Tt | Haze |
| Ref. 1 | A4360 | No | Not performed | ◯ | 91.1 | 1.1 | 0.8 | 0.5 | X | 90.4 | 17.7 | 2.1 | 1.3 | X | 88.2 | 33.0 |
| Ref. 2 | 125 μm | | 150° C. × 1 min | ◯ | 90.8 | 1.8 | 0.3 | 0.1 | X | 90.3 | 19.4 | 1.9 | 1.0 | X | 86.8 | 49.3 |
| | | | 150° C. × 5 min | X | 90.7 | 5.1 | 0.2 | 0.1 | X | 90.6 | 17.2 | 1.8 | 0.9 | X | 87.3 | 31.5 |
| | | | 150° C. × 10 min | X | 90.7 | 8.7 | 0.1 | 0.0 | X | 90.0 | 20.7 | 1.8 | 0.9 | X | 88.8 | 26.3 |
| | | | 200° C. × 1 min | X | 91.0 | 4.9 | 0.0 | 0.1 | X | 90.0 | 20.1 | 1.3 | 0.7 | X | 87.5 | 38.9 |
| | | | 200° C. × 5 min | X | 90.6 | 15.2 | 0.0 | 0.0 | X | 90.1 | 19.3 | 0.7 | 0.4 | X | 87.8 | 40.1 |
| | | | 200° C. × 10 min | X | 89.8 | 23.6 | 0.0 | 0.0 | X | 90.2 | 17.9 | 0.4 | 0.2 | X | 88.0 | 43.3 |
| C. Ex. 1 | | 3 | Not performed | ◯ | 91.9 | 0.4 | 0.7 | 0.5 | ◯ | 91.9 | 0.3 | 1.5 | 1.0 | ◯ | 91.7 | 0.3 |
| Ex. 1 | | | 150° C. × 1 min | ◯ | 91.8 | 0.5 | 0.3 | 0.2 | ◯ | 91.9 | 0.4 | 1.2 | 0.7 | ◯ | 91.7 | 0.4 |
| | | | 150° C. × 5 min | ◯ | 91.8 | 0.3 | 0.1 | 0.1 | ◯ | 91.9 | 0.4 | 1.0 | 0.6 | ◯ | 91.7 | 0.4 |
| | | | 150° C. × 10 min | ◯ | 91.9 | 0.3 | 0.1 | 0.1 | ◯ | 91.9 | 0.4 | 0.9 | 0.6 | ◯ | 91.7 | 0.3 |
| | | | 200° C. × 1 min | ◯ | 91.8 | 0.5 | 0.0 | 0.1 | ◯ | 91.9 | 0.3 | 0.7 | 0.5 | ◯ | 91.8 | 0.3 |
| | | | 200° C. × 5 min | ◯ | 91.9 | 0.5 | 0.0 | 0.0 | ◯ | 91.8 | 0.3 | 0.4 | 0.3 | ◯ | 91.7 | 0.4 |
| | | | 200° C. × 10 min | ◯ | 91.8 | 0.4 | 0.0 | 0.0 | ◯ | 91.8 | 0.3 | 0.1 | 0.1 | ◯ | 91.8 | 0.3 |
| | | | 200° C. × 20 min | ◯ | 91.8 | 0.3 | 0.0 | 0.0 | ◯ | 91.7 | 0.3 | 0.1 | 0.1 | ◯ | 91.7 | 0.3 |
| | | | 200° C. × 30 min | ◯ | 91.8 | 0.4 | 0.0 | 0.0 | ◯ | 91.7 | 0.3 | 0.0 | 0.1 | ◯ | 91.2 | 0.4 |
| C. Ex. 2 | | 6 | Not performed | ◯ | 91.8 | 0.4 | 0.7 | 0.5 | ◯ | 91.7 | 0.4 | 1.3 | 0.9 | ◯ | 91.7 | 0.4 |
| Ex. 2 | | | 200° C. × 10 min | ◯ | 91.7 | 0.4 | 0.0 | 0.0 | ◯ | 91.7 | 0.4 | 0.1 | 0.1 | ◯ | 91.6 | 0.4 |
| | | | 200° C. × 20 min | ◯ | 91.7 | 0.4 | 0.0 | 0.0 | ◯ | 91.5 | 0.5 | 0.1 | 0.1 | ◯ | 91.5 | 0.4 |
| | | | 200° C. × 30 min | ◯ | 91.6 | 0.4 | 0.0 | 0.0 | ◯ | 91.5 | 0.4 | 0.0 | 0.1 | ◯ | 91.5 | 0.4 |

*Ref: Reference Example
C. Ex: Comparative Example
Ex: Example
◯: No change was observed,
X: Change was observed

As is apparent from the results of Table 1, Examples of the present invention satisfying the conditions (I) and (II) of the present invention can provide a hard coat film having high heat resistance and dimension stability and suppressing deterioration of appearance and change of shape by carrying out annealing treatment in addition to hard coating. On the other hand, in Comparative Example in which annealing treatment is not carried out, a hard coat film satisfying high heat resistance, dimensional stability, and optical properties cannot be obtained. Furthermore, in Reference Example, whitening or deformation was observed.

1. A hard coat film comprising hard coat layers on both surfaces of a base material film, each hard coat layer containing an ionizing radiation curable resin composition, the hard coat film satisfying the following conditions (I) and (II), and having a maximum value of a heat shrinkage rate of 1.2% or less after the hard coat film is heat-treated at 150° C. to 200° C. for 1 minute to 30 minutes:
condition (I): the ionizing radiation curable resin composition contains an acrylic resin including a (meth)acryloyl group; and
condition (II): the ionizing radiation curable resin composition contains inorganic fine particles or organic fine particles.

2. The hard coat film according to claim 1, wherein a content of the inorganic fine particles or the organic fine particles is in a range from 1% by mass to 60% by mass relative to a solid content of the ionizing radiation curable resin composition.

3. The hard coat film according to claim 1, wherein when D_{A} denotes a film thickness of a hard coat layer A on a first surface of the base material film and D_{B} denotes a film thickness of a hard coat layer B on a second surface of the base material film, the film thickness D_{A} of the hard coat layer A and the film thickness D_{B} of the hard coat layer B are both in a range from 0.5 μm to 12.0 μm.

4. The hard coat film according to claim 1, wherein a film thickness ratio ((D_{A}/D_{B})×100) of the hard coat layer A to the hard coat layer B is in a range from 50% to 150%.

5. The hard coat film according to claim 1, wherein the base material film is selected from polyethylene terephthalate, cycloolefin, polyethylene naphthalate, polyimide, triacetylcellulose, and liquid crystal polymer.

6. The hard coat film according to claim 1, wherein the inorganic fine particles include silica or alumina.

7. A method for producing a hard coat film comprising hard coat layers on both surfaces of a base material film, each hard coat layer containing an ionizing radiation curable resin composition, the method comprising:
coating each of the both surfaces of the base material film with an ionizing radiation curable resin composition containing an acrylic resin including a (meth)acryloyl group, and inorganic fine particles or organic fine particles, and drying, followed by irradiation with ionizing radiation to form a hard coat layer cured on each of the both surfaces of the base material film, and subjecting the obtained hard coat film to annealing treatment.

8. The method for producing a hard coat film according to claim 7, wherein the annealing treatment is carried out at 150° C. to 200° C. for 1 minute to 30 minutes.

9. The method for producing a hard coat film according to claim 7, wherein a content of the inorganic fine particles or the organic fine particles is in a range from 1% by mass to 60% by mass relative to a solid content of the ionizing radiation curable resin composition.

10. The method for producing a hard coat film according to claim 7, wherein the hard coat film having a maximum value of a heat shrinkage rate of 1.2% or less after the hard coat film is heat-treated at 150° C. to 200° C. for 1 minute to 30 minutes.

11. The method for producing a hard coat film according to claim 7, wherein the base material film is selected from polyethylene terephthalate, cycloolefin, polyethylene naphthalate, polyimide, triacetylcellulose, and liquid crystal polymer.
